(19) United States
(12) Patent Application Publication
(10) Pub. No.: US 2019/0266860 A1
(43) Pub. Date: Aug. 29, 2019

(54) BUILDING EVACUATION MANAGEMENT SYSTEM

(71) Applicant: CARRIER CORPORATION, Palm Beach Gardens, FL (US)

(72) Inventors: Prasad Babu LAKSHMIPATHY, Hyderabad, Telangana (IN); Nagarani PADURU, Hyderabad, Telangana (IN); Balaji KALIAPPAN, Hyderabad, Telangana (IN)

(73) Assignee: Carrier Corporation, Palm Beach Gardens, FL (US)

(21) Appl. No.: 16/320,385

(22) PCT Filed: Jul. 20, 2017
(86) PCT No.: PCT/US2017/043002

§ 371 Date: Jan. 24, 2019

(30) Foreign Application Priority Data
Jul. 26, 2016 (IN) 201611025558

(51) Int. Cl. G08B 7/06; H04M 1/725; G08B 21/02; G06K 9/62; G06K 9/00

(52) U.S. Cl. CPC G08B 7/066; H04M 1/72577; G06K 9/00362; G06K 9/6201; G08B 21/02

(57) ABSTRACT

A method and apparatus to manage a building evacuation of at least one building occupant in response to an emergency event in a building is provided, the method including detecting the emergency event via at least one emergency sensor, providing an emergency event signal corresponding to the emergency event via the at least one emergency sensor to a building management system, and providing an alert to at least one occupant device associated with the at least one building occupant via the building management system, wherein the alert includes a building floor plan.

### DESCRIPTION OF RELATED ART

The subject matter disclosed herein relates to building management systems, and to a system and a method for providing alerts to building occupants during an emergency event.

Typically, evacuation routes and floor plans are statically displayed within a building at predetermined locations. For example, evacuation routes may be located near exits and stairwells of a building. Building occupants may be unfamiliar with a given floor of a building. Advantageously, providing evacuation routes and floor plans can allow occupants to quickly and safely exit a building during an emergency event.

Building occupants often utilize a number of personal and public devices such as personal mobile devices and public use televisions. Current evacuation systems may utilize statically displayed evacuation routes and floor plans, but may not provide evacuation routes and floor plans to building occupants in convenient locations and in a timely manner. A system and method that can provide alerts to building occupants during an emergency event is desired.

### BRIEF SUMMARY

According to an embodiment, a method to manage a building evacuation of at least one building occupant in response to an emergency event in a building is provided, the method including detecting the emergency event via at least one emergency sensor, providing an emergency event signal corresponding to the emergency event via the at least one emergency sensor to a building management system, and providing an alert to at least one occupant device associated with the at least one building occupant via the building management system, wherein the alert includes a building floor plan.

In addition to one or more of the features described above, or as an alternative, further embodiments could include locating the emergency event within the building via the at least one emergency sensor.

In addition to one or more of the features described above, or as an alternative, further embodiments could include that the emergency sensors include: a smoke detector, a heat detector, and a carbon monoxide detector.

In addition to one or more of the features described above, or as an alternative, further embodiments could include that the at least one occupant device includes a personal occupant device and a public occupant device.

In addition to one or more of the features described above, or as an alternative, further embodiments could include that the personal occupant device is a personal occupant mobile device or a personal occupant computer.

In addition to one or more of the features described above, or as an alternative, further embodiments could include restricting functionality of the personal occupant device in response to the alert.

In addition to one or more of the features described above, or as an alternative, further embodiments could include tracking a location of the personal occupant device.

In addition to one or more of the features described above, or as an alternative, further embodiments could include providing a location parameter to the at least one building occupant via the personal occupant device.

In addition to one or more of the features described above, or as an alternative, further embodiments could include that the public occupant device includes a public computer and a public display.

In addition to one or more of the features described above, or as an alternative, further embodiments could include providing the building floor plan to the building management system.

In addition to one or more of the features described above, or as an alternative, further embodiments could include identifying at least one point of interest of the building floor plan.

In addition to one or more of the features described above, or as an alternative, further embodiments could include storing at least one image corresponding to the at least one building occupant via an image database, capturing at least one evacuation image of the at least one building occupant via an image capture device, and comparing the at least one evacuation image of the at least one building occupant to the at least one stored image of the at least one building occupant.

In addition to one or more of the features described above, or as an alternative, further embodiments could include providing an occupant report corresponding to the comparison of the at least one evacuation image to the at least one stored image.

According to an embodiment, a system to manage a building evacuation of a building occupant in response to an emergency event in a building is provided, the a system including at least one emergency sensor to detect the emergency event and provide an emergency event signal corresponding to the emergency event, a building management system to receive the emergency event signal, and at least one occupant device associated with the at least one building occupant to receive an alert from the building management system, wherein the alert includes a building floor plan.

In addition to one or more of the features described above, or as an alternative, further embodiments could include an image database containing at least one image corresponding to the at least one building occupant, and an image capture device to capture at least one evacuation image of the at least one building occupant and compare the at least one evacuation image of the at least one building occupant to the at least one stored image of the at least one building occupant.

Technical function of the embodiments described above includes providing an alert to at least one occupant device associated with the at least one building occupant via the building management system, wherein the alert includes a building floor plan.

Other aspects, features, and techniques of the embodiments will become more apparent from the following description taken in conjunction with the drawings.

### BRIEF DESCRIPTION OF THE SEVERAL VIEWS OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the several FIGURES:

FIG. 1 illustrates a schematic view of an evacuation management system; and

FIG. 2 is a flow diagram of a method of managing a building evacuation.

### DETAILED DESCRIPTION

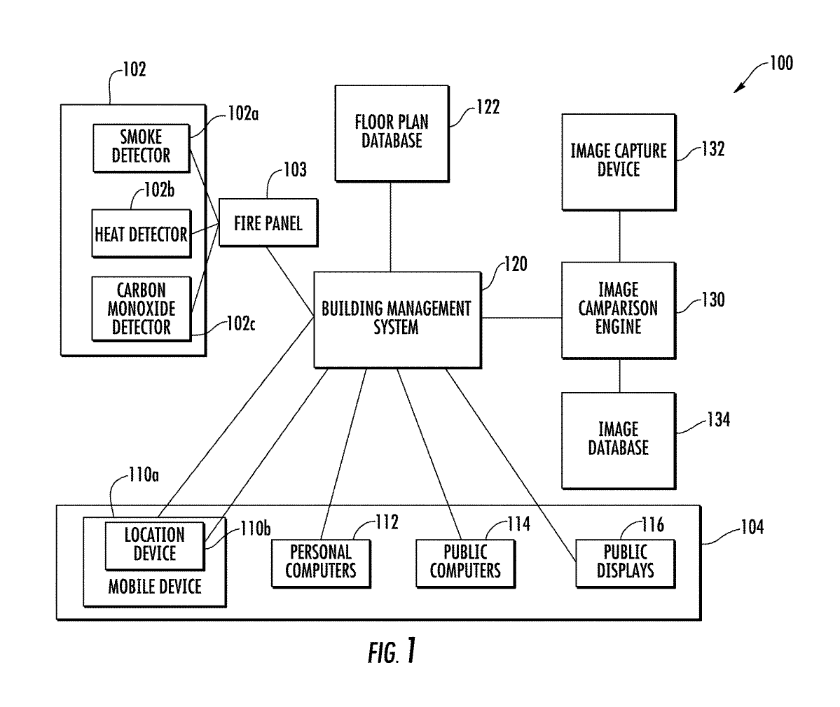

Referring now to the drawings, FIG. 1 illustrates a schematic view of an evacuation management system 100. In the illustrated embodiment, the evacuation management system 100 includes at least one emergency sensor 102, a building management system 120, and an occupant device 104. In the illustrated embodiment, the evacuation management system 100 can be utilized for managed buildings such as office buildings with known occupants or unmanaged buildings such as malls, etc. without known occupants. The evacuation management system 100 can provide evacuation routes and building floor plans to occupants via occupant devices 104 to allow for safer evacuations in response to emergency events. In certain embodiments, the evacuation management system 100 can further identify occupants that have exited the building as well as occupants that may remain within the building using image capture devices. Advantageously, the evacuation management system 100 can allow for occupants to be evacuated in less time while minimizing responder involvement. Further, the evacuation management system 100 can be utilized at a wide variety of buildings wherein the building occupants are either managed or unmanaged.

In the illustrated embodiment, the evacuation management system 100 can include emergency sensors 102. The emergency sensors 102 can include, but are not limited to a smoke detector 102a, a heat detector 102b, and a carbon monoxide detector 102c. In the illustrated embodiment, the emergency sensors 102 can detect parameters that may indicate that an emergency or otherwise abnormal condition is occurring. In the illustrated embodiment, the emergency sensors 102 can be any suitable sensor to be disposed within the building. The emergency sensors 102 can be disposed in any suitable location within the building. In certain embodiments, the location of the emergency sensors 102 can be utilized to determine the location of a perceived emergency event. In certain embodiments, the emergency sensors 102 can detect emergency events as well as perform other building functions such as climate control, access control, etc. In certain embodiments, at least some of the emergency sensors 102 can be connected to a fire panel 103 to provide additional fire response services. The fire panel 103 can further communicate with the building management system 120.

In the illustrated embodiment, the building management system 120 can receive signals from the emergency sensors 102 and provide alerts and guidance to occupant devices 104. In the illustrated embodiment, the building management system 120 can interface with the emergency sensors 102, occupant devices 104, and a floor plan database 122. In certain embodiments, the building management system 120 can further interface with an image comparison engine 130. In the illustrated embodiment, the building management system 120 can be a computerized system that is utilized for emergency and evacuation purposes. In other embodiments, the building management system 120 can be utilized for other building management purposes in addition to emergency or evacuation services.

In the illustrated embodiment, the floor plan database 122 stores floor plan records corresponding to various floors of the subject building. In the illustrated embodiment, floor plan records can provide a layout of a building floor. Floor plans can be surveyed or taken from building records to be loaded into the floor plan database 122. In the illustrated embodiment, points of interest such as exit points for each floor can be identified in the floor plan record to allow evacuation routes to be determined. Further, additional points of interest can be identified to identify obstacles, alternate entry/exit points, etc.

In certain embodiments, the floor plan records can be stored as an image within the floor plan database 122. Further, the floor plan records can include dimensions and measurements to facilitate guidance to occupants as needed. Advantageously, floor plan records can be created once and utilized as needed.

In the illustrated embodiment, the building management system 120 can monitor the emergency sensors 102. The building management system 120 can identify parameters or events that may indicate that an emergency event is occurring. In the illustrated embodiment, the building management system 120 can determine if an emergency event that is detected requires an evacuation. In certain embodiments, the building management system 120 can manually prompt an administrator to determine if an evacuation is required. In certain embodiments, evacuations can be full building evacuations or partial building evacuations, requiring evacuation of select floors or areas.

In the illustrated embodiment, the building management system 120 can utilize the location of the emergency sensors 102 to locate the emergency event. In the illustrated embodiment, the building management system 120 can identify evacuation routes based on the location of the emergency event. In other embodiments, the building management system 120 can identify and create evacuation routes based on the floor plan records from the floor plan database 122 and the information received from the emergency sensors 102.

In the illustrated embodiment, the building management system 120 can send an alert to occupant devices 104 in response to an evacuation determination. In the illustrated embodiment, the occupant devices 104 can include personal devices, such as mobile devices 110a and personal computers 112, and public devices, such as public computers 114 and public displays 116.

In the illustrated embodiment, mobile devices 110a and personal computers 112 can be each treated as devices associated with a specific occupant within the building. In certain embodiments, mobile devices 110a may further include a location device 110b. The location device 110b can include GPS device or any other suitable location device to provide a location of the mobile device 110a to the building management system 120. Mobile devices 110a can be carried, held or otherwise associated with building occupants. In the illustrated embodiment, the mobile devices 110a can be mobile phones, etc. or any suitable device that is associated with each building occupant to provide a representative location of each building occupant. Therefore, mobile devices 110a can be utilized to provide locations to the building management system 120.

In the illustrated embodiment, personal computers 112 can be computing devices that are associated with a given occupant. Personal computers 112 are intended to be used by a single occupant and can be at a fixed location or can be a portable computer that the occupant may transport. Personal computers 112 may provide a location to the building management system 120 based on location devices within the personal computer such as network interfaces, etc.

In the illustrated embodiment, public devices such as public computers 114 and public displays 116 may interact with the building management system 120. In the illustrated embodiment, public computers 114 may be publically accessible by multiple occupants. Public computers 114 and public displays 116 may be easily viewable or accessible by multiple building occupants. Public displays 116 include televisions and other large displays. In certain embodiments, the location of public computers 114 and public displays 116 can be known to the building management system 120.

In the illustrated embodiment, in response to an evacuation condition, the building management system 120 can send an evacuation alert to the occupant devices 104. The received alert can be displayed via the occupant device 104 either for a single occupant or for multiple occupants. In the illustrated embodiment, the occupant devices 104 can display a relevant map from the floor plan database 122. The displayed map can include relevant exits as well as routing based on the location of the occupant device 104. Advantageously, the layout and routing displayed can correspond to the location of the occupant devices as well as the location of the emergency event. In the illustrated embodiment, the occupant devices 104 can automatically display the evacuation route and map in response to receiving the alert from the building management system 120.

In certain embodiments, various devices can receive different alerts and provide different behaviors in response to the alert. For example, in certain embodiments, personal devices such as a mobile device 110a and personal computers 112 may restrict functionality in response to an evacuation alert, to encourage occupants to evacuate in a timely manner. Restricting functionality may be determined by an administrator or in response to various emergency events. In certain embodiments, functionality of the personal devices such as mobile device 110a and personal computers 112 can be selectively restricted and restored as desired by an administrator or user.

In certain embodiments, mobile devices 110a can further track the location of an occupant associated with the mobile device 110a to provide guidance toward building exits. In certain embodiments, audio prompts can be utilized to direct occupants. The mobile device 110a can further download information prior to an emergency event to allow guidance functionality when network connectivity is not available.

During a building evacuation, an image capture device 132 can be utilized to capture images of building occupants to determine an occupant headcount or to prepare a report of occupants remaining inside the building. In the illustrated embodiment, the image comparison engine 130 works with image capture device 132 and image database 134. For managed buildings with known occupants, the image comparison engine 130 can be utilized to determine remaining building occupants that have not evacuated the building. For unmanaged buildings with unknown occupants, the image comparison engine 130 can be utilized to provide a headcount.

In certain embodiments, images of each occupant can be stored in the image database 134. The images can be recorded at a prior time and can be linked to access control systems within the building. Therefore, access control systems can be utilized to identify relevant images of occupants that may be within the building. For managed buildings, images captured from the image capture device 132 can be compared to stored images within the image database 134. The image comparison engine 130 can compare the captured image to the stored image to identify building occupants that have exited the building. As a result, the image comparison engine 130 can provide data to the building management system 120 to determine building occupants that have not evacuated the building. This report can be provided to first responders as needed.

In other embodiments, such as unmanaged buildings, the image capture device 132 can be utilized to provide a headcount of building occupants that have exited the building. This information can be provided to first responders to estimate building occupants that may remain inside the building. In certain embodiments, the image comparison engine 130 can include technology that can be utilized to identify and count occupants that have exited the building.

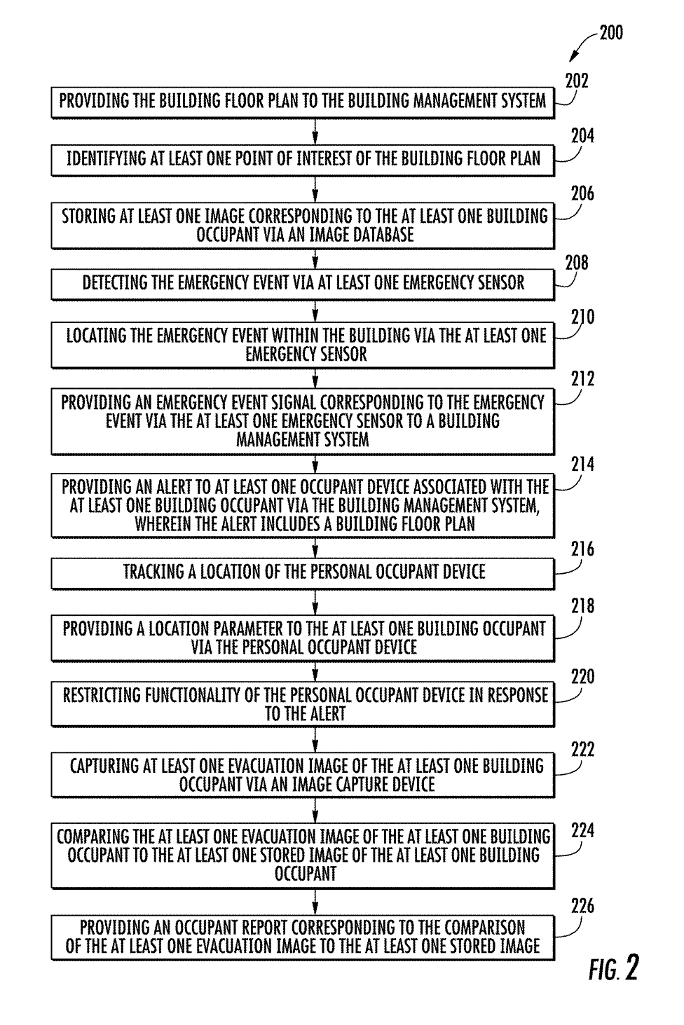

Referring to FIG. 2, a method 200 for managing building occupants during an evacuation is shown. In operation 202, the building floor plan is provided to the building management system. In the illustrated embodiment, the floor plan database stores floor plan records corresponding to various floors of the subject building. In the illustrated embodiment, floor plan records can provide a layout of a building floor. Floor plans can be surveyed or taken from building records to be loaded into the floor plan database.

In operation 204, at least one point of interest of the building floor plan is identified. In the illustrated embodiment, points of interest such as exit points for each floor can be identified in the floor plan record to allow evacuation routes to be determined. Further, additional points of interest can be identified to identify obstacles, alternate entry/exit points, etc.

In operation 206, at least one image corresponding to the at least one building occupant is stored via an image database. In certain embodiments, images of each occupant can be stored in the image database. The images can be recorded at a prior time and can be linked to access control systems within the building. Therefore, access control systems can be utilized to identify relevant images of occupants that may be within the building.

In operation 208, the emergency event is detected via at least one emergency sensor. The emergency sensors can include, but are not limited to a smoke detector, a heat detector and a carbon monoxide detector. In the illustrated embodiment, the emergency sensors can detect parameters that may indicate that an emergency or otherwise abnormal condition is occurring.

In operation 210, the emergency event is located within the building via the at least one emergency sensor. In certain embodiments, the location of the emergency sensors can be utilized to determine the location of a perceived emergency event.

In operation 212, an emergency event signal corresponding to the emergency event is provided via the at least one emergency sensor to a building management system. In the illustrated embodiment, the building management system can determine if an emergency event that is detected requires an evacuation. In certain embodiments, the building management system can manually prompt an administrator to determine if an evacuation is required. In certain embodiments, evacuations can be full building evacuations or partial building evacuations, requiring evacuation of select floors or areas.

In operation 214, an alert to at least one occupant device associated with the at least one building occupant is provided via the building management system, wherein the alert includes a building floor plan.

In operation 216, a location of the personal occupant device is tracked. In operation 218, a location parameter to the at least one building occupant is provided via the personal occupant device. In certain embodiments, mobile devices can further track the location of an occupant associated with the mobile device to provide guidance toward building exits. In certain embodiments, audio prompts can be utilized to direct occupants. The mobile device can further download information prior to an emergency event to allow guidance functionality when network connectivity is not available.

In operation 220, functionality of the personal occupant device is restricted in response to the alert. In certain embodiments, functionality of the personal occupant device can be selectively restricted and restored as desired by an administrator or user. In operation 222, at least one evacuation image of the at least one building occupant is captured via an image capture device. During a building evacuation, an image capture device can be utilized to capture images of building occupants to determine an occupant headcount or to prepare a report of occupants remaining inside the building.

In operation 224, the at least one evacuation image of the at least one building occupant is compared to the at least one stored image of the at least one building occupant. For managed buildings, images captured from the image capture device can be compared to stored images within the image database. The image comparison engine can compare the captured image to the stored image to identify building occupants that have exited the building.

In operation 226, an occupant report corresponding to the comparison of the at least one evacuation image to the at least one stored image is provided. As a result, the image comparison engine can provide data to the building management system to determine building occupants that have not evacuated the building. This report can be provided to first responders as needed.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope of the embodiments. Additionally, while various embodiments have been described, it is to be understood that aspects may include only some of the described embodiments. Accordingly, the embodiments are not to be seen as limited by the foregoing description, but are only limited by the scope of the appended claims.

What is claimed is:

1. A method to manage a building evacuation of at least one building occupant in response to an emergency event in a building, the method comprising:
detecting the emergency event via at least one emergency sensor;
providing an emergency event signal corresponding to the emergency event via the at least one emergency sensor to a building management system; and
providing an alert to at least one occupant device associated with the at least one building occupant via the building management system, wherein the alert includes a building floor plan.

2. The method of claim 1, further comprising locating the emergency event within the building via the at least one emergency sensor.

3. The method of claim 1, wherein the emergency sensors include: a smoke detector, a heat detector, and a carbon monoxide detector.

4. The method of claim 1, wherein the at least one occupant device includes a personal occupant device and a public occupant device.

5. The method of claim 4, wherein the personal occupant device is a personal occupant mobile device or a personal occupant computer.

6. The method of claim 5, further comprising restricting functionality of the personal occupant device in response to the alert.

7. The method of claim 5, further comprising tracking a location of the personal occupant device.

8. The method of claim 7, further comprising providing a location parameter to the at least one building occupant via the personal occupant device.

9. The method of claim 4, wherein the public occupant device includes a public computer and a public display.

10. The method of claim 1, further comprising providing the building floor plan to the building management system.

11. The method of claim 1, further comprising identifying at least one point of interest of the building floor plan.

12. The method of claim 1, further comprising:
storing at least one image corresponding to the at least one building occupant via an image database;
capturing at least one evacuation image of the at least one building occupant via an image capture device; and
comparing the at least one evacuation image of the at least one building occupant to the at least one stored image of the at least one building occupant.

13. The method of claim 12, further comprising providing an occupant report corresponding to the comparison of the at least one evacuation image to the at least one stored image.

14. A system to manage a building evacuation of a building occupant in response to an emergency event in a building, the system comprising:
at least one emergency sensor to detect the emergency event and provide an emergency event signal corresponding to the emergency event;
a building management system to receive the emergency event signal; and
at least one occupant device associated with the at least one building occupant to receive an alert from the building management system, wherein the alert includes a building floor plan.

15. The system of claim 14, further comprising:
an image database containing at least one image corresponding to the at least one building occupant; and
an image capture device to capture at least one evacuation image of the at least one building occupant and compare the at least one evacuation image of the at least one building occupant to the at least one stored image of the at least one building occupant.
